(19) United States
(12) Patent Application Publication
(10) Pub. No.: US 2008/0288560 A1
(43) Pub. Date: Nov. 20, 2008

(54) STORAGE MANAGEMENT METHOD USING DATA MIGRATION

(76) Inventors: Tomoyuki Kaji, Kamakura (JP); Takaki Kuroda, Machida (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,259

(22) Filed: Jan. 2, 2008

(30) Foreign Application Priority Data
May 15, 2007 (JP) 2007-129126

(51) Int. Cl. G06F 17/30

(52) U.S. Cl. 707/204; 707/E17.001

(57) ABSTRACT

Selection of a migration source volume and a migration destination volume of an implemented migration is accepted. Based on a completion date and time of the implemented migration and an update date and time of the volume, it is determined whether or not the selected migration source volume and migration destination volume are updated after the completion of the implemented migration. When it is determined that both the migration source volume and the migration destination volume are not updated, the implemented migration is undone by setting a storage subsystem to allow a host computer to make access to the migration source volume.

### CLAIM OF PRIORITY

The present application claims priority from Japanese patent application JP 2007-129126 filed on May 15, 2007, the content of which is hereby incorporated by reference into this application.

### BACKGROUND

This invention relates to a technique of simplifying management of a storage system, in particular, a method of undoing implemented data migration.

In recent years, a data capacity handled in a storage system is expected to increase. Therefore, the simplification and automation of setting in a storage area network (SAN) environment are an important issue.

With the increase in the amount of data, migration for migrating data to another storage device (data migration) is sometimes required due to a change in access frequency or the like. For example, due to a lowered access frequency, data is required to be migrated from a storage device having higher processing performance to another storage device having lower processing performance. When migration is required to be undone, for example, in a case where the processing performance is lower than supposed, the migration is required to be implemented again.

In such a case, it is effective to provide a migration undo function. U.S. Pat. No. 7,093,088 discloses a technique of performing a finalization determining operation at the time when migration is implemented. According to this technique, the implementation of migration can be undone in the finalization determining operation.

### SUMMARY

According to the technique disclosed in U.S. Pat. No. 7,093,088, however, the migration cannot be undone after the finalization determining operation. In the case where the migration process is required to be undone after the finalization of migration, migration is required to be performed again with a migration source and a migration destination being swapped.

This invention has an object of providing a method of undoing migration by a simple operation even after the completion of migration.

A representative aspect of this invention is as follows. That is, there is provided a data migration management method for a computer system having a storage subsystem, a host computer coupled to the storage subsystem, and a management server capable of accessing to the storage subsystem, the storage subsystem having a port coupled to the host computer and a storage device coupled to the port, for storing data to be read from and written to the host computer; the storage subsystem providing a storage area of the storage device for the host computer as a volume; the management server comprising an interface coupled to the storage subsystem, a processor coupled to the interface, and a memory coupled to the processor; the memory storing migration management information including execution date and time of migration for copying data stored in the volume to another volume and volume management information including update date and time of the volume; and the data migration method comprising the steps of: executing, by the processor, the migration; receiving, by the processor, the selection of the migration source volume and the migration destination volume of the executed migration; determining, by the processor, whether or not the selected migration source volume and the selected migration destination volume are updated after completion of the executed migration based on the migration management information and the volume management information; and undoing, by the processor, the executed migration by setting the storage subsystem so that the host computer can access the selected migration source volume when it is determined that both of the migration source volume and the migration destination volume are not updated.

According to an aspect of this invention, even after the completion of migration, the migration can be undone by a simple operation.

### BRIEF DESCRIPTION OF THE DRAWINGS

The present invention can be appreciated by the description which follows in conjunction with the following figures, wherein:

FIG. 1 is a block diagram showing a system configuration of a computer system in accordance with an embodiment of this invention;

FIG. 2 is a block diagram showing a configuration of a management server in accordance with the embodiment of this invention;

FIG. 3 is a diagram showing an example of a migration management table in accordance with the embodiment of this invention;

FIG. 4 is a diagram showing an example of the volume management table in accordance with the embodiment of this invention;

FIG. 5 is a flowchart showing a procedure of migration in accordance with the embodiment of this invention;

FIG. 6 is a diagram showing a volume selection screen for designating the migration source volume or the migration destination volume in accordance with the embodiment of this invention;

FIG. 7 is a diagram showing a procedure of migration and states of migration target volumes in accordance with the embodiment of this invention;

FIG. 8 is a flowchart showing a procedure of undoing the implemented migration in accordance with the embodiment of this invention;

FIG. 9 is a diagram showing a list of states of the migration source volume and the migration destination volume when the migration undo process in accordance with the embodiment of this invention;

FIG. 10 is a diagram showing a case where a plurality of times of migration is implemented for a specific volume in accordance with the embodiment of this invention; and

FIG. 11 is a flowchart showing a procedure of collectively undoing migration for the volumes included in the migration group according to the embodiment of this invention.

### DETAILED DESCRIPTION OF THE PREFERRED EMBODIMENT

Hereinafter, a mode for carrying out this invention will be described with reference to the accompanying drawings.

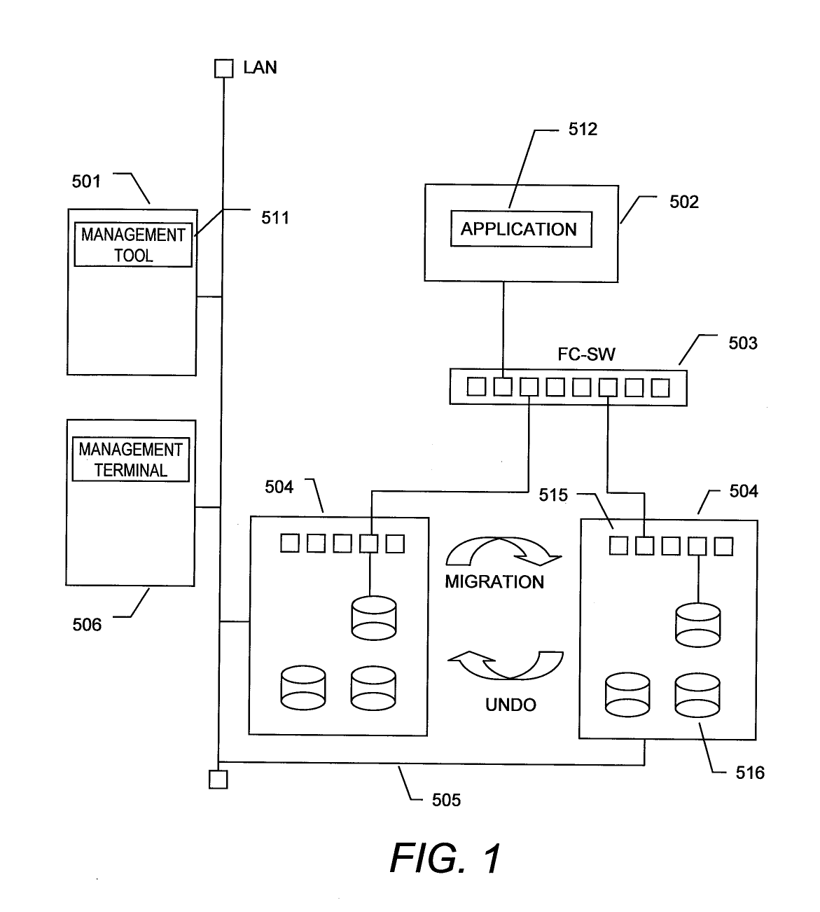

FIG. 1 illustrates a system configuration of a computer system according to an embodiment of this invention.

The computer system according to the embodiment of this invention includes a management server 501, a host computer 502, a fibre channel switch 503, storage subsystems 504, and a management terminal 506.

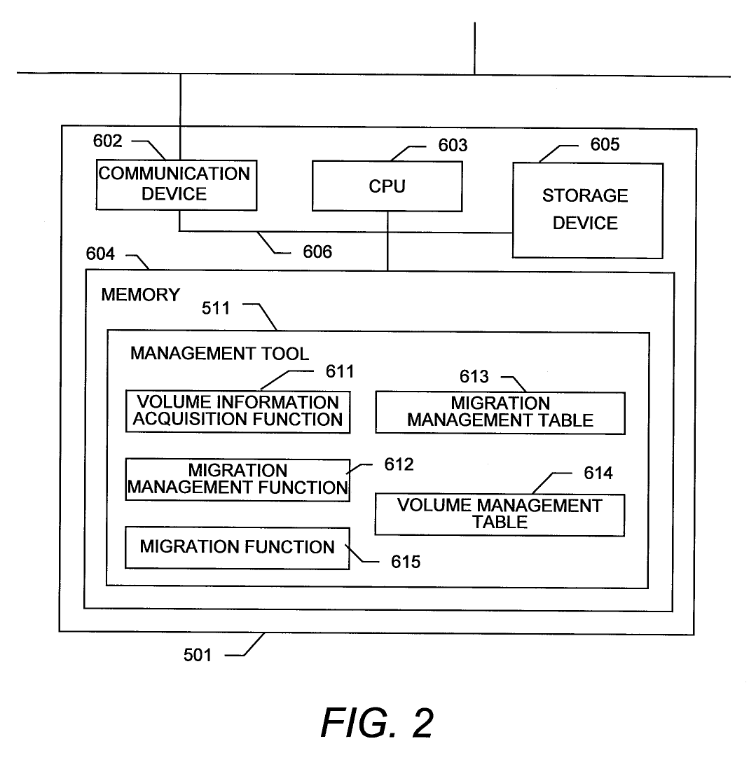

The management server 501 manages the storage subsystems 504 and includes a management tool 511. The management server 501 implements a function included in the management tool 511 in response to an instruction from the management terminal 506 to manage the storage subsystems 504. The details of the management server 501 will be described below with reference to FIG. 2.

The host computer 502 executes an application 512 to perform task processing. The host computer 502 is, for example, a workstation system, a mainframe computer, or a personal computer. The host computer 502 uses data stored in the storage subsystems 504 to execute task processing such as database processing, Web application processing, and streaming processing.

The fibre channel switch 503 connects various devices, each having a fibre channel interface, to each other. The fibre channel switch 503 connects a plurality of servers and a storage system to each other to create a SAN. In the embodiment of this invention, the host computer 502 and the storage subsystems 504 are connected to each other through the fibre channel switch 503.

Each of the storage subsystems 504 includes a control unit (not shown), ports 515, and a storage device 516. The control unit executes processing requested by the host computer 502. The port 515 is connected to the fibre channel switch 503.

The storage device 516 stores data to be read and written in response to a request from the host computer 502. The storage device 516 is a physical device which actually stores data. More specifically, a fibre channel (FC) disk drive, a serial advanced technology attachment (SATA) disk drive, and a small computer system interface (SCSI) disk drive are cited as examples. With the physical device, a semiconductor memory such as a flash memory can also be used as the storage device 516.

A LAN 505 is connected to the management server 501, the storage subsystems 504, and the management terminal 506. The management terminal 506 makes access to the management server 501 through the LAN 505 to set and display management information.

FIG. 2 illustrates a configuration of the management server 501 according to the embodiment of this invention. The management server 501 includes a communication device 602, a CPU 603, a memory 604, and a storage device 605.

The communication device 602 is an interface connecting to the LAN 505. The management server 501 connects to the network through the communication device 602.

The CPU 603 executes a program stored in the memory 604 to execute various processes.

The memory 604 stores a program executed by the CPU 603 and data required for the process. The memory 604 stores the management tool 511 which includes a program and data for managing the storage subsystem 504.

The management tool 511 may be stored in the storage device 605 to be read out and stored in the memory 604 for execution. The program included in the management tool 511 is executed to allow the CPU 603 to obtain information from the storage subsystem 504 or to issue a setting request to the storage subsystem 504.

The management tool 511 includes a volume information acquisition function 611, a migration management function 612, and a migration function 615. The volume information acquisition function 611, the migration management function 612, and the migration function 615 are programs for executing the respective functions. The management tool 511 includes a migration management table 613 and a volume management table 614.

The volume information acquisition function 611 manages the volume management table 614. The migration management function 612 manages the migration management table 613.

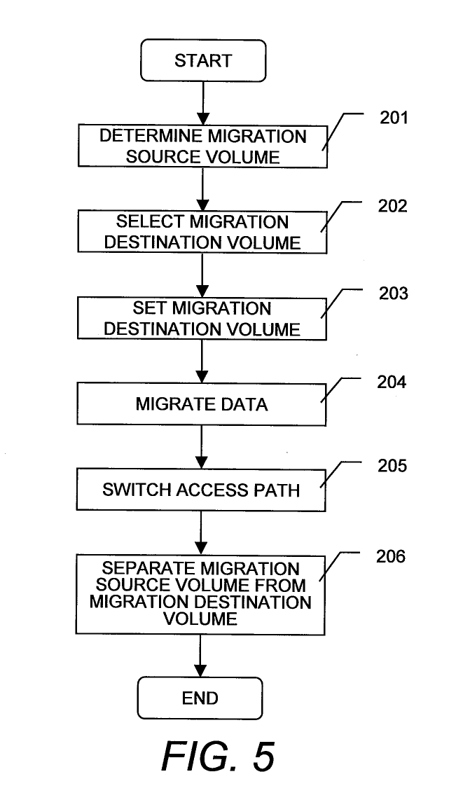

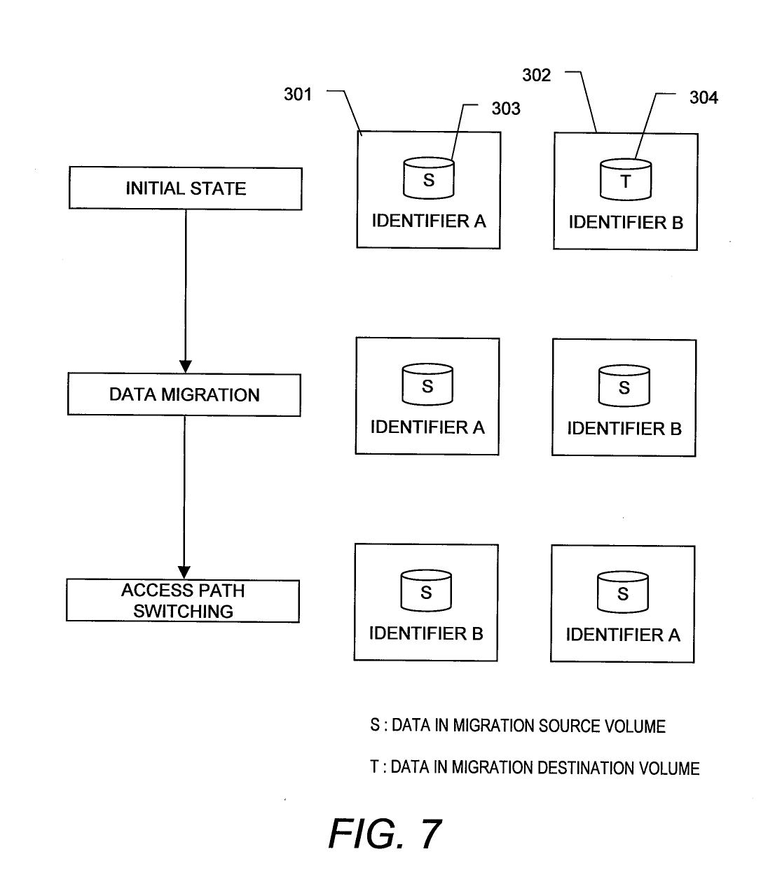

The migration function 615 implements migration and undoes the implemented migration. The details of the process of migration will be described below with reference to FIG. 5, whereas the details of the migration undo process will be described below with reference to FIG. 7.

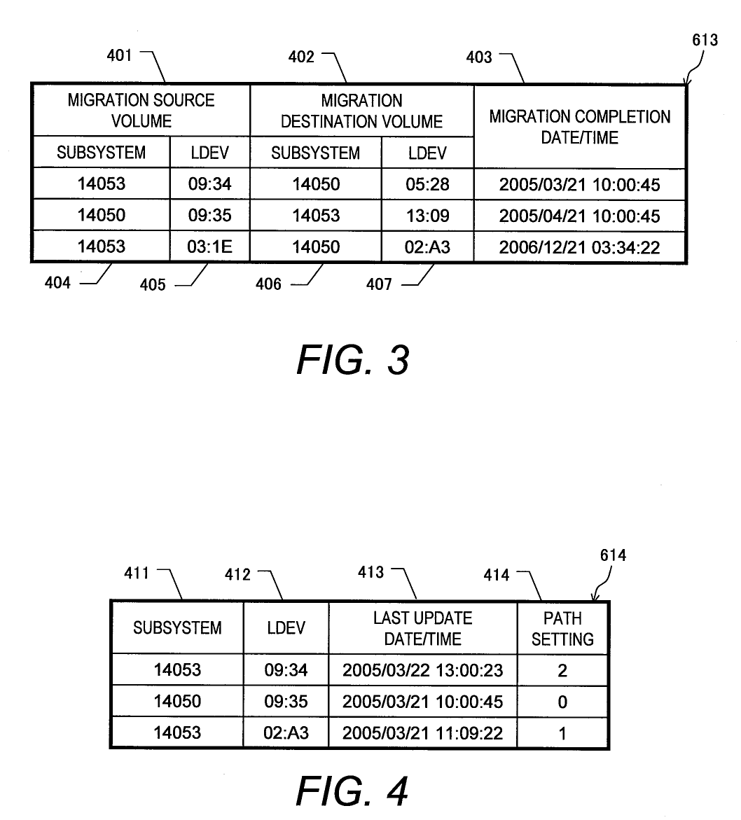

The migration management table 613 stores the correspondence relation between a migration source volume and a migration destination volume of the implemented migration, and a date and a time of completion of the migration. The details of the migration management table 613 will be described below with reference to FIG. 3.

The volume management table 614 stores the last update date and time of a volume and information indicating whether or not a path is set, which are provided by the storage system 504. The details of the volume management table 614 will be described below with reference to FIG. 4.

FIG. 3 illustrates an example of configuration of the migration management table 613 according to the embodiment of this invention. The migration management table 613 includes a migration source volume 401, a migration destination volume 402, and a migration completion date and time 403.

Upon execution and completion of migration, a new record is added to the migration management table 613.

The migration source volume 401 is information for identifying a volume which has stored the data. The migration source volume 401 includes a subsystem 404 and an LDEV 405. The subsystem 404 stores an identifier of the storage subsystem 504 which now stores the migration source volume. The LDEV 405 stores an identifier of a logical device provided by the storage subsystem 504 corresponding to the migration source volume.

The migration destination volume 402 is information for identifying a volume which will store the data by the migration. A subsystem 406 stores an identifier of the storage subsystem 504 which stores the migration destination volume. A LDEV 407 stores an identifier of a logical device provided by the storage subsystem 504 corresponding to the migration destination volume.

The migration completion date and time 403 stores a date and a time at which the implementation of migration is completed.

A record stored in the migration management table 613 may be deleted from the migration management table 613 when the data stored in the migration source volume is updated after the implementation of migration.

FIG. 4 illustrates an example of configuration of the volume management table 614 according to the embodiment of this invention. The volume management table 614 includes a subsystem 411, an LDEV 412, a last update date and time 413, and a path setting 414. Upon creation of a new volume in the storage subsystem 504, a new record is added to the volume management table 614.

The subsystem 411 stores an identifier of the storage subsystem 504. The LDEV 412 stores an identifier of a logical device provided by the storage subsystem 504.

The last update date and time 413 stores a date and a time at which the host computer 502 accepts the last write request addressed to the volume identified by the subsystem 411 and the LDEV 412.

The path setting 414 stores whether or not a path is set in the volume identified by the subsystem 411 and the LDEV 412. A value stored in the path setting 414 is the number of logical paths connected from the volume to the ports in the subsystem.

FIG. 5 is a flowchart illustrating a procedure of migration according to the embodiment of this invention. The migration is implemented by the CPU 603 which processes the migration function 615.

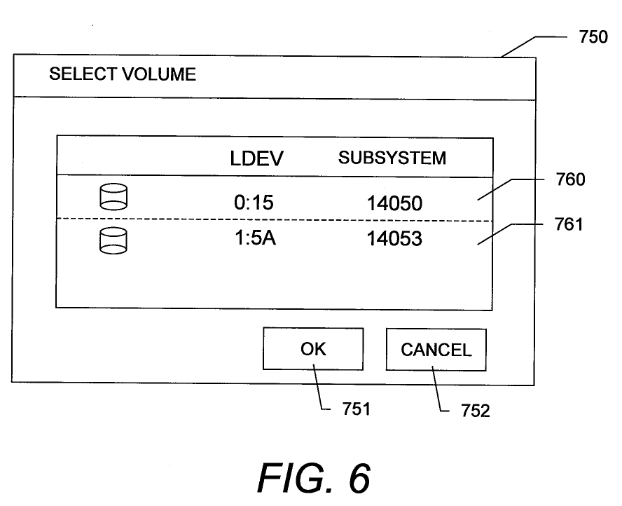

The CPU 603 first accepts the designation of a migration source volume (Step 201). The migration source volume is designated by an administrator who operates the management terminal 506. The designation of the migration source volume is input, for example, through a volume selection screen which will be described below with reference to FIG. 6.

In the process of Step 201, for example, when a file accessed by the application 512 in the host computer 502 is to be migrated, a volume provided by the storage subsystem including the file to be migrated is referred to as the migration source volume.

FIG. 6 illustrates a volume selection screen 750 for designating the migration source volume or the migration destination volume according to the embodiment of this invention. The volume selection screen 750 is displayed on the management terminal 506 by an instruction of a user when the migration is to be implemented or undone.

The volume selection screen 750 displays candidates for the migration source volume or the migration destination volume. FIG. 6 illustrates volumes 760 and 761 as candidates for the migration source volume or the migration destination volume. Before the display of the volume selection screen 750, a screen for inputting conditions may be displayed to display candidate volumes based on the input conditions.

After selecting the migration source volume or the migration destination volume, the user operates an OK button 751 to determine the selection of the volume. When a cancel button 752 is operated, the process is interrupted. Alternatively, upon operation of the cancel button 752, the process may return to the previous screen such as the condition selection screen.

Now, the description returns to the flowchart of FIG. 5 illustrating the procedure of migration.

Upon determination of the migration source volume, the CPU 603 accepts the selection of the migration destination volume (Step 202). The CPU 603 displays the volume selection screen 750 shown in FIG. 6 to accept the selection of the migration destination volume.

For the migration process, there exist conditions; for example, a capacity of the migration source volume must be equal to that of the migration destination volume. The detailed description of the conditions is herein omitted because specific conditions differ for each storage subsystem. The volume selection screen 750 displays a migration destination volume candidate based on the selected migration source volume.

Upon selection of the migration destination volume, the CPU 603 performs setting required for the migration destination volume. The CPU 603 updates the management information stored in the management server 501 and instructs the host computer 502, the storage subsystem 504, and the like to update the management information to be stored. Specific setting items include a process of setting a path for the port 515 included in the storage subsystem 504 and a process of causing the host computer 502 side to recognize the migration destination volume as a drive. Those settings differ for each type of storage subsystem and each function to be used.

Upon completion of various settings, the CPU 603 migrates the data stored in the migration source volume to the migration destination volume (Step 204). Specifically, the data stored in the migration source volume is copied to the migration destination volume to synchronize the migration source volume and the migration destination volume with each other. The term “data migration” in this embodiment of this invention means copying the data stored in the migration source volume to the migration destination volume. The copied data in the migration source volume is retained without being deleted if the migration source volume is not used again.

The CPU 603 sets a path so that the destination of an access request issued from the host computer 502 is changed from the migration source volume to the migration destination volume, thereby switching the access path (Step 205). At this time, the CPU 603 updates values of the path setting 414 in the volume management table 614, which correspond to the migration source volume and the migration destination volume.

The CPU 603 releases the migration source volume. Further, the CPU 603 terminates a synchronized state of the migration source volume and the migration destination volume (Step 206).

Upon completion of the process of Step 206 to complete the migration, the CPU 603 adds a record to the migration management table 613.

The migration management table 613 stores information identifying the migration source volume determined in the process of Step 201 and information identifying the migration destination volume selected in the process of Step 202 are stored in the migration source volume 401 and the migration destination volume 402, respectively. Further, a time at which the record is added is stored in the migration completion date and time 403.

FIG. 7 illustrates a procedure of migration and states of migration target volumes according to the embodiment of this invention. Referring to FIG. 7, an initial state, a state after the execution of the process of Step 204, and a state after the execution of the process of Step 205 will be described.

The system illustrated in FIG. 7 includes array groups 301 and 302. The array group 301 includes a migration source volume 303, whereas the array group 302 includes a migration destination volume 304.

In the initial state, the migration source volume 303 is identified by an identifier A, whereas the migration destination volume 304 is identified by an identifier B. The migration source volume 303 holds data S, whereas the migration destination volume 304 holds data T.

When the “data migration” process is implemented (Step 204), the data T in the migration destination volume 304 is updated to the data S. At this time, both the migration source volume 303 and the migration destination volume 304 store the data S.

Further, when an “access path switching” process is implemented (Step 205), the identifier of the migration source volume 303 and the identifier of the migration destination volume 304 are swapped. An identifier of the volume is, for example, a numerical value uniquely assigned to each volume. Since the host computer 502 makes access based on the identifier assigned to the volume, the host computer 502 can make access to the migration destination volume 304 after the access path is switched, as in the case of access to the migration source volume 303.

Now, a procedure of undoing of the migration after completion of the migration will be described. As described above, by implementing the migration again after the designation of the migration source volume and that of the migration destination volume are swapped, the migration can be undone.

As illustrated in FIG. 7, however, when both the setting of the migration source volume and that of the migration destination volume are not changed or the data in the migration source volume and that in the migration destination volume are not updated after the implementation of migration, the “data migration” process (Step 204 in FIG. 5) is not required. When a size of the data stored in the volume is large, the cost required for the “data migration” process is high. Therefore, the cost required for undoing the migration can be remarkably reduced.

The embodiment of this invention provides a method of simply and quickly undoing the implemented migration by referring to update information of the volume after the implementation of migration to implement the data migration process only when needed.

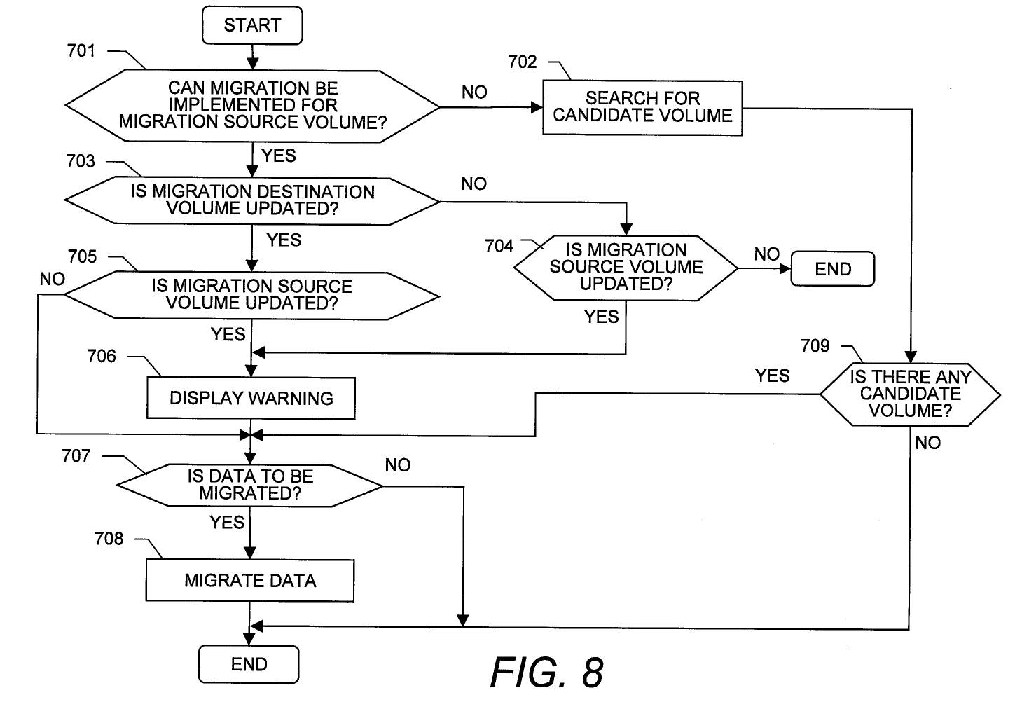

FIG. 8 is a flowchart illustrating a procedure of undoing the implemented migration according to the embodiment of this invention.

This process is implemented when a storage administrator undoes the implemented migration after the completion of implementation of the migration. This process is performed by the CPU 603 which implements the migration function 615 of the management tool 511 stored in the memory 604.

In the flowchart shown in FIG. 8, “the migration source volume” designates a volume corresponding to a migration source in the last implemented migration, whereas “the migration destination volume” designates a volume corresponding to a migration destination in the last implemented migration.

The CPU 603 is required to specify the migration source volume and the migration destination volume before the execution of this process. For specifying the migration source volume and the migration destination volume, there is a method of accepting the designation of the migration destination volume accessed by the host computer 502 and identifying the migration source volume with reference to the migration management table 613. Alternatively, the designation of the implemented migration itself may be accepted to identify the migration source volume and the migration destination volume.

The CPU 603 first determines whether or not the migration can be implemented for the migration source volume (Step 701). In other words, the CPU 603 determines whether or not the data in the migration destination volume can be migrated to the migration source volume. The implementation of the migration for the migration source volume can be determined based on whether or not the migration source volume is used after the completion of the migration. More specifically, with reference to the volume management table 614, when a value in the path setting 414 is “0”, it is determined that the migration can be implemented. When a value in the path setting 414 is “0”, no path is connected to the migration source volume to allow no access from the host computer 502 and the like. Therefore, it can be determined that the migration source volume is not used at the time of execution of this process.

When the migration cannot be implemented for the migration source volume (result of Step 701 is “NO”), the CPU 603 searches for another volume for which the migration can be implemented (Step 702).

The CPU 603 determines whether or not there is any candidate volume(s) found in the search of the process of Step 702 (Step 709). When there is a candidate volume (result of Step 709 is “YES”), the process of Step 707 is implemented. Further, when there is a candidate volume, the candidate volume is presented to a user. On the other hand, when there is no candidate volume (result of Step 709 is “NO”), this process is terminated because the migration cannot be implemented.

When the migration can be implemented for the migration source volume (result of Step 701 is “YES”), the CPU 603 determines whether or not the migration destination volume is updated after the “last migration” (Step 703). The update of the migration destination volume after the “last migration” is determined by comparing the migration completion date and time 403 of the “last migration” in the migration management table 613 and the last update date and time 413 of the migration destination volume in the volume management table 614 with each other.

When the migration destination volume is not updated (result of Step 703 is “NO”), the CPU 603 determines whether or not the migration source volume is updated after the “last migration” (Step 704). As in the case of the process of Step 703, the update of the migration source volume is determined by comparing the migration completion date and time 403 in the migration management table 613 and the last update date and time 413 of the migration destination volume in the volume management table 614 with each other.

In the embodiment of this invention, even when it is determined that the migration can be implemented for the migration source volume (no path is set) in the process of Step 701, it is confirmed whether or not the migration source volume has been changed. At the time when the user implements the migration undo operation, there is a possibility that a path is set before the execution of the migration undo operation and therefore the data is updated even when the number of paths set for the migration source volume is 0.

When the migration source volume is not updated (result of Step 704 is “NO”), the CPU 603 terminates this process. This is because the contents in the migration source volume and those in the migration destination volume are the same and therefore it is not necessary to migrate the data. In this case, only the access path switching is performed without migrating the data.

When the migration destination volume is updated (result of Step 703 is “YES”), the CPU 603 determines whether or not the migration source volume is updated (Step 705).

When the migration source volume is updated (result of Step 704 is “YES” or the result of Step 705 is “YES”), the CPU 603 warns the user of the update data in the migration source volume being overwritten by the migration (Step 706).

The CPU 603 accepts the confirmation if the data migration is to be actually implemented (Step 707). The process of Step 707 is implemented after the warning is issued in the process of Step 706, after a volume different from the migration source volume is found in the search of the process of Step 702 and is then presented to the user, and when the migration source volume is not updated in the process of Step 705.

When accepting an instruction of execution of the data migration from the user (result of Step 707 is “YES”), the CPU 603 instructs the storage subsystem 504 to migrate the data in the migration destination volume to the migration source volume (Step 708).

When the migration source volume and the migration destination volume are not changed (result of Step 704 is “YES”) or when the data in the migration destination volume is copied to the migration source volume (Step 708), the contents in the migration source volume and those in the migration destination volume are the same after the termination of this process. Therefore, after the termination of this process, by setting a path to change the destination of an access request issued from the host computer 502 from the migration source volume to the migration destination volume to switch the access path, the implemented migration can be undone.

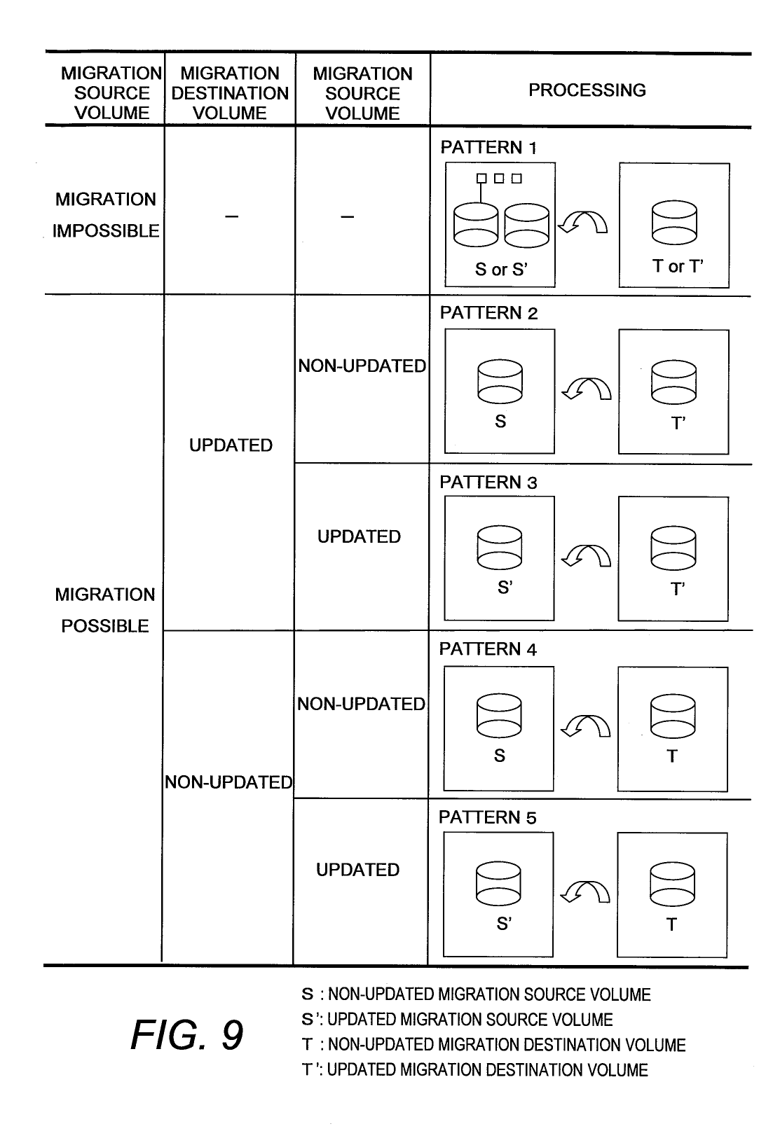

FIG. 9 illustrates a list of states of the migration source volume and the migration destination volume when the migration undo process according to the embodiment of this invention is implemented. FIG. 9 shows the different states as Patterns 1 to 5 depending on whether or not the migration can be implemented for the migration source volume and the update/non-update of the migration source volume and the migration destination volume. Hereinafter, a process in each pattern will be described with the process of the flowchart shown in FIG. 8.

Pattern 1 shows a case where the migration cannot be implemented for the migration source volume. When the migration cannot be implemented for the migration source volume (result of Step 701 is “NO”), a candidate volume different from the migration source volume is searched from the storage subsystem 504 (Step 702). When the candidate volume is found in the search (result of Step 709 is “YES”), the data in the migration destination volume can be migrated to the candidate volume found in the search. In Pattern 1, the data cannot be migrated because, for example, the migration source volume is used by another system. Therefore, it is not necessary to determine whether or not the data stored in the migration source volume and the migration destination volume are updated.

Pattern 2 shows a case where the migration can be implemented for the migration source volume (result of Step 701 is “YES”), the migration destination volume is updated (result of Step 703 is “YES”), and the migration source volume is not updated (result of Step 705 is “NO”).

In Pattern 2, the migration source volume is not updated. Therefore, after it is confirmed whether or not the data is to be migrated (Step 707), the data in the migration destination volume is migrated to the migration source volume (Step 708).

Pattern 3 shows a case where the migration can be implemented for the migration source volume (result of Step 701 is “YES”), the migration destination volume is updated (result of Step 703 is “YES”), and the migration source volume is updated (result of Step 705 is “YES”).

In Pattern 3, the migration source volume is updated. Therefore, the user is warned of the update data stored in the migration source volume being overwritten by the migration (Step 706). After warning, it is confirmed whether the data is to be migrated or not (Step 707). Then, the data in the migration destination volume is migrated to the migration source volume (Step 708).

Pattern 4 shows a case where the migration can be implemented for the migration source volume (result of Step 701 is “YES”), the migration destination volume is not updated (result of Step 703 is “NO”), and the migration source volume is not updated (result of Step 704 is “NO”).

In Pattern 4, because the migration source volume and the migration destination volume are not updated, the migration can be undone by changing the path setting to switch the access path.

Pattern 5 shows a case where the migration can be implemented for the migration source volume (result of Step 701 is “YES”), the migration destination volume is not updated (result of Step 703 is “NO”), and the migration source volume is updated (result of Step 704 is “YES”).

In Pattern 5, the migration source volume is updated. Therefore, the user is warned of the update data stored in the migration source volume being overwritten by the migration (Step 706). After warning, it is confirmed whether the data is to be migrated or not (Step 707). Then, the data in the migration destination volume is migrated to the migration source volume (Step 708).

In the flowchart shown in FIG. 8, the process of undoing the “last implemented migration” is described. However, the number of times of migration implemented for the volume is not necessarily one. Therefore, a process of undoing the migration when a plurality of times of migration is implemented for the volume will be described.

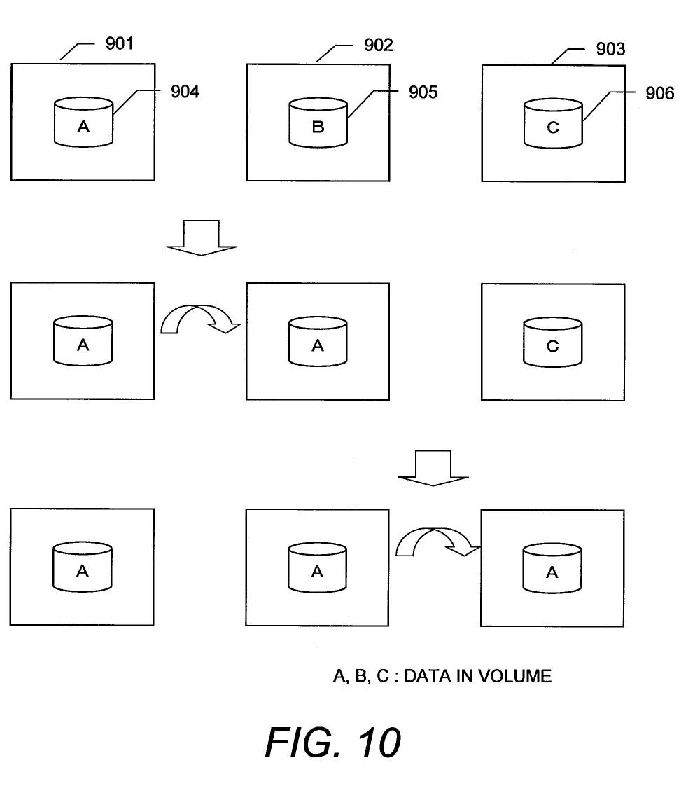

FIG. 10 is a view illustrating a case where a plurality of times of migration is implemented for a specific volume according to the embodiment of this invention. Array groups 901, 902 and 903 are represented in FIG. 10.

The array group 901 includes a volume 904. In the same manner, the array group 902 includes a volume 905, and the array group 903 includes a volume 906. In the initial state (the upper row of FIG. 10), the volume 904 holds data A. In the same manner, the volume 905 holds data B, and the volume 906 holds data C.

Herein, a case where a plurality of times of migration is implemented for the volumes 904 to 906 will be described as an example.

First, as the first migration, migration for migrating the data A in the volume 904 to the volume 905 is implemented. At this time, because the data A is copied to the volume 905, the data B is overwritten by the data A (the middle row of FIG. 10).

Next, as the second migration, migration for migrating the data A in the volume 905 to the volume 906 is implemented. At this time, because the data A is copied to the volume 906, the data C is overwritten by the data A (the lower row of FIG. 10).

Now, a case where an administrator undoes the migration of the volume 906 to the volume 904 in the array group 901 will be described.

The CPU 603 refers to the migration management table 613 to thereby obtain information of the migration regarding the volume 906 as the migration destination volume. Further, by obtaining information of the migration regarding the migration source volume of the obtained migration as the migration destination volume, the history of migration can be obtained.

The CPU 603 refers to the history of migration to thereby obtain the volume to which the data A is migrated. Further, the CPU 603 can obtain a time period for which the data A has been stored, based on the migration completion date and time 403. Therefore, by referring to the volume management table 614, the CPU 603 can determine, for the volume to which the data A is migrated, whether or not the data A has been updated within the time period for which the data A has been stored.

For example, if the data A is not updated from the completion of the migration from the volume 904 to the volume 905 to the implementation of migration undo and the volumes 904 and 905 are not updated by another system and the like, the data A in the same state is stored in the volumes 904 to 906. In this case, the path setting is changed to switch the access path. As a result, the migration can be quickly undone without migrating the data.

This process can be used not as the migration undo process but can be used for the implementation of migration using the volume 906 as the migration source volume and the volume 904 as the migration destination volume as well. More specifically, the history of migration of the volume 906 is obtained. With reference to the obtained history, it is determined whether or not the migration destination volume is contained. When the migration destination volume is contained, the volume management table 614 is referred to, as described above. In this manner, it is determined whether or not the data A has been updated within the time period for which the data A has been stored, for the volume to which the data A is migrated.

In the processes of Step 704 and 705 shown in FIG. 8, not only by determining the update of the migration source volume but also by obtaining the history of migration to determine the data update for each volume to which the data is migrated, the application of this invention is not limited to the last migration.

Next, a method of collectively implementing or undoing migration for a plurality of volumes will be described.

A plurality of volumes, for which migration is collectively implemented, is managed as a migration group. The execution or undo of the migration is implemented by accepting the designation of the migration group. When the migration is implemented for the migration group, the migration destination volume for the volume included in the migration group is individually designated.

Further, when the migration is undone collectively, the migration undo is implemented for each of the volumes included in the migration group.

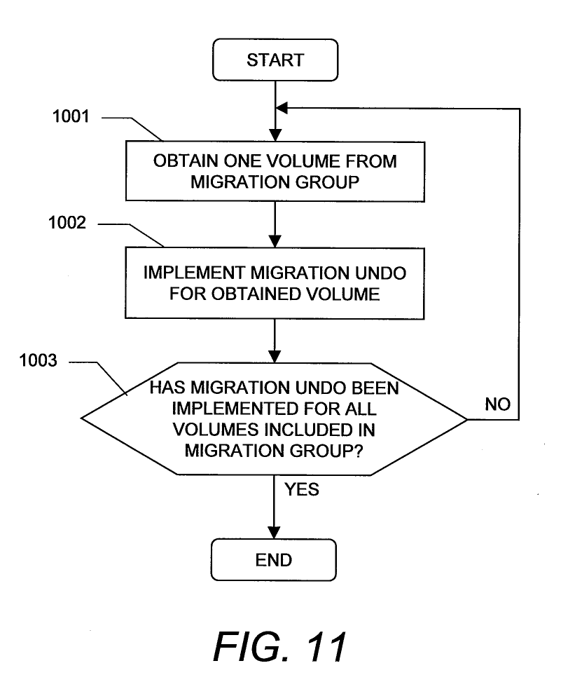

FIG. 11 illustrates a procedure of collectively undoing migration for the volumes included in the migration group according to the embodiment of this invention.

The CPU 603 selects a volume for which the migration is undone, from the volumes included in the migration group (Step 1001).

The CPU 603 implements the migration undo process for the volume selected in the process of Step 1001 (Step 1002). In the process of Step 1002, the migration undo process is implemented for a single volume. Therefore, it is sufficient to implement the migration undo process for the selected volume based on the procedure shown in the flowchart of FIG. 8.

Upon completion of the migration undo process for the selected volume, the CPU 603 determines whether or not the migration undo process has been completed for all the volumes included in the migration group (Step 1003).

In a case where the migration undo process has not been completed for all the volumes included in the migration group (result of Step 1003 is “NO”), the CPU 603 returns to Step 1001. In a case where the migration undo process has been completed for all the volumes included in the migration group (result of Step 1003 is “YES”), this process is terminated.

When the above-mentioned process is executed, the migration undo process can be implemented collectively for a plurality of volumes.

According to the embodiment of this invention, the migration undo can be implemented based on the states of the migration source volume and the migration destination volume. Therefore, when both the migration source volume and the migration destination volume are not updated, the path setting is changed to switch the access path. In this manner, the migration can be easily undone.

Moreover, according to the embodiment of this invention, even when a plurality of times of migration is implemented, the history of implementation of migration for the data stored in the migration destination volume by referring to the migration management table 613. In this manner, the migration can be undone.

Further, according to the embodiment of this invention, the migration for a plurality of volumes can be collectively undone. When the migration is implemented for a migration group as a unit, management cost can be reduced. Therefore, by undoing the migration for a migration group as a unit, the management cost can be further reduced.

While the present invention has been described in detail and pictorially in the accompanying drawings, the present invention is not limited to such detail but covers various obvious modifications and equivalent arrangements, which fall within the purview of the appended claims.

What is claimed is:

1. A data migration management method for a computer system having a storage subsystem, a host computer coupled to the storage subsystem, and a management server capable of accessing to the storage subsystem,
the storage subsystem having a port coupled to the host computer and a storage device coupled to the port, for storing data to be read from and written to the host computer;
the storage subsystem providing a storage area of the storage device for the host computer as a volume;
the management server comprising an interface coupled to the storage subsystem, a processor coupled to the interface, and a memory coupled to the processor;
the memory storing migration management information including execution date and time of migration for copying data stored in the volume to another volume and volume management information including update date and time of the volume; and
the data migration method comprising the steps of:
executing, by the processor, the migration;
receiving, by the processor, the selection of the migration source volume and the migration destination volume of the executed migration;
determining, by the processor, whether or not the selected migration source volume and the selected migration destination volume are updated after completion of the executed migration based on the migration management information and the volume management information; and
undoing, by the processor, the executed migration by setting the storage subsystem so that the host computer can access the selected migration source volume when it is determined that both of the migration source volume and the migration destination volume are not updated.

2. The data migration management method according to claim 1, wherein:
the migration management information includes information for identifying the migration source volume and information for identifying the migration destination volume; and
the data migration method further comprises the steps of:
obtaining, by the processor, a migration history including the information of the migration source volume having stored the data stored in the selected migration destination volume based on the migration management information;
determining, by the processor, whether or not the data stored in the selected migration source volume is updated before being stored in the selected migration destination volume based on the migration history and the volume management information; and
determining, by the processor, that both of the selected migration source volume and the selected migration destination volume are not updated when it is determined that the data stored in the selected migration source volume is not updated.

3. The data migration management method according to claim 1, further comprising the step of instructing, by the processor, the storage subsystem to copy the data stored in the selected migration destination volume to the selected migration source volume when it is determined that the selected migration source volume is not updated and the selected migration destination volume is updated.

4. The data migration management method according to claim 1, further comprising the step of instructing, by the processor, the storage subsystem to copy the data stored in the selected migration destination volume to the selected migration source volume when it is determined that both of the selected migration source volume and the selected migration destination volume are updated.

5. The data migration management method according to claim 1, further comprising the step of instructing, by the processor, the storage subsystem to copy the data stored in the selected migration destination volume to the selected migration source volume when it is determined that the selected migration source volume is updated and the selected migration destination volume is not updated.

6. The data migration management method according to claim 1, further comprising the steps of:
determining, by the processor, whether or not the data stored in the selected migration destination volume can be copied to the selected migration source volume;
searching, by the processor, for a volume to which the data can be copied when the data stored in the selected migration destination volume cannot be copied to the selected migration source volume; and
presenting, by the processor, the volume found in the search as a candidate of a migration destination volume.

7. The data migration management method according to claim 1, wherein:
the selected migration source volume is managed by a migration group including a plurality of volumes; and
the data migration method further comprises the step of using, by the processor, each of the volumes included in the migration group as the selected migration source volume.

8. The data migration management method according to claim 1, further comprising the steps of:
determining, by the processor, whether or not data stored in the selected migration destination volume can be copied to the selected migration source volume;
searching, by the processor, for a volume to which the data can be copied to present the volume found in the search as a candidate migration destination volume when the data stored in the selected migration destination volume cannot be copied to the selected migration source volume;
presenting, by the processor, when the data stored in the selected migration destination volume can be copied to the selected migration source volume, execution of overwrite of update of the selected migration source volume when the selected migration source volume is updated, and instructing the storage subsystem to copy the data stored in the selected migration destination volume to the selected migration source volume; and
instructing, by the processor, when it is determined that the selected migration source volume is not updated whereas the selected migration destination volume is updated, the storage subsystem to copy the data stored in the selected migration destination volume to the selected migration source volume.

9. A computer system, comprising:
a storage subsystem;
a host computer coupled to the storage subsystem; and
a management server capable of accessing the storage subsystem, wherein:
the storage subsystem comprises a port coupled to the host computer and a storage device coupled to the port, for storing data to be read from and written to the host computer, the storage subsystem providing a storage area of the storage device for the host computer as a volume;
the management server comprises an interface coupled to the storage subsystem, a processor coupled to the interface, and a memory coupled to the processor;
the memory stores migration management information including execution date and time of migration for copying data stored in the volume to another volume and volume management information including update date and time of the volume; and
the management server is configured to:
execute the migration;
receive the selection of the migration source volume and the migration destination volume of the executed migration;
determine whether or not the selected migration source volume and the selected migration destination volume are updated after completion of the executed migration based on the migration management information and the volume management information; and
undo the executed migration by setting the storage subsystem so that the host computer can access the selected migration source volume when it is determined that both of the selected migration source volume and the selected migration destination volume are not updated.

10. The computer system according to claim 9, wherein:
the migration management information includes information for identifying the migration source volume and information for identifying the migration destination volume; and
the management server is further configured to:
obtain a migration history including information of the migration destination volume having the data stored in the selected migration destination volume based on the migration management information;
determine whether or not the data stored in the selected migration source volume is updated before being stored in the selected migration destination volume based on the migration history and the volume management information; and
determine that both of the selected migration source volume and the selected migration destination volume are not updated when it is determined that the data stored in the selected migration source volume is not updated.

11. The computer system according to claim 9, wherein the management server is further configured to instruct the storage subsystem to copy the data stored in the selected migration destination volume to the selected migration source volume when it is determined that the selected migration source volume is not updated and the selected migration destination volume is updated.

12. The computer system according to claim 9, wherein the management server is further configured to instruct the storage subsystem to copy the data stored in the selected migration destination volume to the selected migration source volume when it is determined that both of the selected migration source volume and the selected migration destination volume are updated.

13. The computer system according to claim 9, wherein the management server is further configured to instruct the storage subsystem to copy the data stored in the selected migration destination volume to the selected migration source volume when it is determined that the selected migration source volume is updated and the selected migration destination volume is not updated.

14. The computer system according to claim 9, wherein the management server is further configured to:
determine whether or not the data stored in the selected migration destination volume can be copied to the selected migration source volume;
search for a volume to which the data can be copied when the data stored in the selected migration destination volume cannot be copied to the selected migration source volume; and
present the volume found in the search as a candidate of a migration destination volume.

15. The computer system according to claim 9, wherein:
the selected migration source volume is managed by a migration group including a plurality of volumes; and
the management server is further configured to use each of the volumes included in the migration group as the selected migration source volume.

16. A machine readable medium, containing data migration sequence executed by a management server which executes migration for copying data stored in a volume provided by a storage subsystem to a host computer, the medium, containing at least one sequence of instructions that, when executed, causes a machine to:
execute the migration;
receive selection of a migration source volume and a migration destination volume of the data;
determine whether or not the selected migration source volume and the selected migration destination volume are updated after completion of the executed migration based on execution date and time of the migration and update date and time of the selected migration source volume; and
set the storage subsystem so that the host computer can access the selected migration source volume when it is determined that both of the selected migration source volume and the selected migration destination volume are not updated.
